(19) United States
(12) Patent Application Publication
(10) Pub. No.: US 2013/0305916 A1
(43) Pub. Date: Nov. 21, 2013

(54) PNEUMATIC CYLINDER WITH PRESSURE MODERATOR

(71) Applicant: PHD. INC, Fort Wayne, IN (US)

(72) Inventor: Nelson Broman, Bluffton, IN (US)

(73) Assignee: PHD. Inc., Fort Wayne, IN (US)

(21) Appl. No.: 13/863,894

(22) Filed: Apr. 16, 2013

Related U.S. Application Data
(60) Provisional application No. 61/648,314, filed on May 17, 2012.

(51) Int. Cl. F16J 10/00

(52) U.S. Cl. CPC F16J 10/00
USPC 92/169.1; 92/261

(57) ABSTRACT

A fluid cylinder assembly including a cylinder, a rod assembly, and a valve assembly. The rod assembly includes a rod having a first end and a second end and a piston connected to the first end of the rod. The piston is slidingly positioned in the cylinder. The second end of the rod extending from the cylinder. The valve assembly is in fluid communication with the cylinder. The valve assembly is configured to moderate pressure within the cylinder when an external force is applied against the second end of the rod.

### CROSS REFERENCE TO RELATED APPLICATIONS

This is a non-provisional application based upon U.S. provisional patent application Ser. No. 61/648,314, entitled “PNEUMATIC CYLINDER WITH PRESSURE MODERATOR”, filed May 17, 2012, which is incorporated herein by reference.

### BACKGROUND OF THE INVENTION

1. Field of the Invention

The invention relates to a pneumatic actuator, and more particularly to a pressure moderated pneumatic cylinder.

2. Description of the Related Art

Pneumatic cylinders are mechanical devices used to provide motive force in a variety of uses including, but not limited to, closing a sliding door. In many of these uses, such as the sliding door, the motive force may present danger of bodily injury if it moves too quickly. In prior art, a simple cylinder comprised of a piston, rod and housing provides the motive force by supplying compressed air to either one or the other side of the piston. When compressed air is directed to the side of the piston opposite the piston rod, the piston rod will extend out of the housing. Also in prior art, if an external force acts to overcome the air pressure on the piston and force the piston rod back into the housing, the developed air pressure inside the cylinder may actually exceed the supplied air pressure if it is not allowed to quickly bleed back into the pressure supply system, to a larger storage vessel or to atmosphere. This excess air pressure inside the cylinder may cause the piston rod to extend too quickly when the external force is removed and present danger of bodily injury. Methods used in prior art to control the speed of the cylinder typically increase the size and complexity of the cylinder thru the addition of external speed dampeners or addition of air flow controls that often do not prevent the excess air pressure caused by external forces.

What is needed in the art is a cost effect apparatus and method of moderating the movement of a pneumatic articulator.

### SUMMARY OF THE INVENTION

The present invention is directed to a pneumatic articulator, and more particularly to a method of moderating the outward movement of the pneumatic articulator after it encounters an opposing force.

The invention in one form is directed to a movable assembly including a movable structure with a fluid cylinder assembly coupled to the movable structure. The fluid cylinder assembly includes a cylinder, a rod assembly, and a valve assembly. The rod assembly includes a rod having a first end and a second end and a piston connected to the first end of the rod. The piston is slidingly positioned in the cylinder. The second end of the rod extending from the cylinder. The valve assembly is in fluid communication with the cylinder. The valve assembly is configured to moderate pressure within the cylinder when an external force is applied against the second end of the rod.

The invention in another form is directed to a fluid cylinder assembly including a cylinder, a rod assembly, and a valve assembly. The rod assembly includes a rod having a first end and a second end and a piston connected to the first end of the rod. The piston is slidingly positioned in the cylinder. The second end of the rod extending from the cylinder. The valve assembly is in fluid communication with the cylinder. The valve assembly is configured to moderate pressure within the cylinder when an external force is applied against the second end of the rod.

The invention in yet another form is directed to a method of moderating a movement of a pneumatic cylinder assembly. The method including the steps of fluidically coupling a valve assembly to the pneumatic cylinder assembly, and of moderating pressure within the pneumatic cylinder by way of a valve position selection such that when an external force is applied against movement of an end of a rod extending from the pneumatic cylinder assembly a substantially equal fluidic pressure is applied to both sides of a piston coupled to the rod.

The present invention is directed to an improved cylinder incorporating features with minimal increase in size or complexity that moderate the development of excess air pressure when an outside force acts on the piston rod—in particular when the outside force acts to force the piston rod back into the cylinder housing.

The present invention provides a pneumatic cylinder with integral cartridge style relay valves used to connect pressurized air to either side of a piston inside the cylinder. The present invention also provides an internal passage to communicate pressurized air from the relay valves in the cap block to the piston rod side of the piston.

To extend the piston rod out of the cylinder the valve circuit communicates pressurized air to both sides of the piston. A net difference in the piston surface areas due to the presence of the piston rod on the rod side of the piston causes an imbalance of applied force on the piston from the pressurized air causing the piston rod to extend. To retract the piston rod back into the cylinder, the valve circuit communicates pressurized air to only the piston rod side of the piston while the air on the opposite side of the piston is exhausted. In prior art the piston rod is relatively small in comparison to the piston size and the net difference in piston areas then yields relatively low force to extend the piston rod. In this embodiment, the piston rod and piston diameters are selected to provide nearly equal net surface areas when pressurized air acts on both sides of the piston to extend the rod and acts only on the piston rod side of the piston to retract the rod. This reduces the physical size of the cylinder that is required in order to produce the desired extending force in the piston rod. By communicating pressurized air to both sides of the piston in order to extend the piston rod, a pathway is provided to maintain balanced air pressure on both sides of the piston when an outside force acts to overcome air pressure and cause the piston rod to retract.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 shows an exploded perspective view of the cylinder assembly according to one embodiment of the present invention; and

FIG. 2 is a schematic view of the cylinder assembly of FIG. 1.

Corresponding reference characters indicate corresponding parts throughout the several views. The exemplification set out herein illustrates an embodiment of the invention, in one form, and such exemplification is not to be construed as limiting the scope of the invention in any manner.

### DETAILED DESCRIPTION OF THE INVENTION

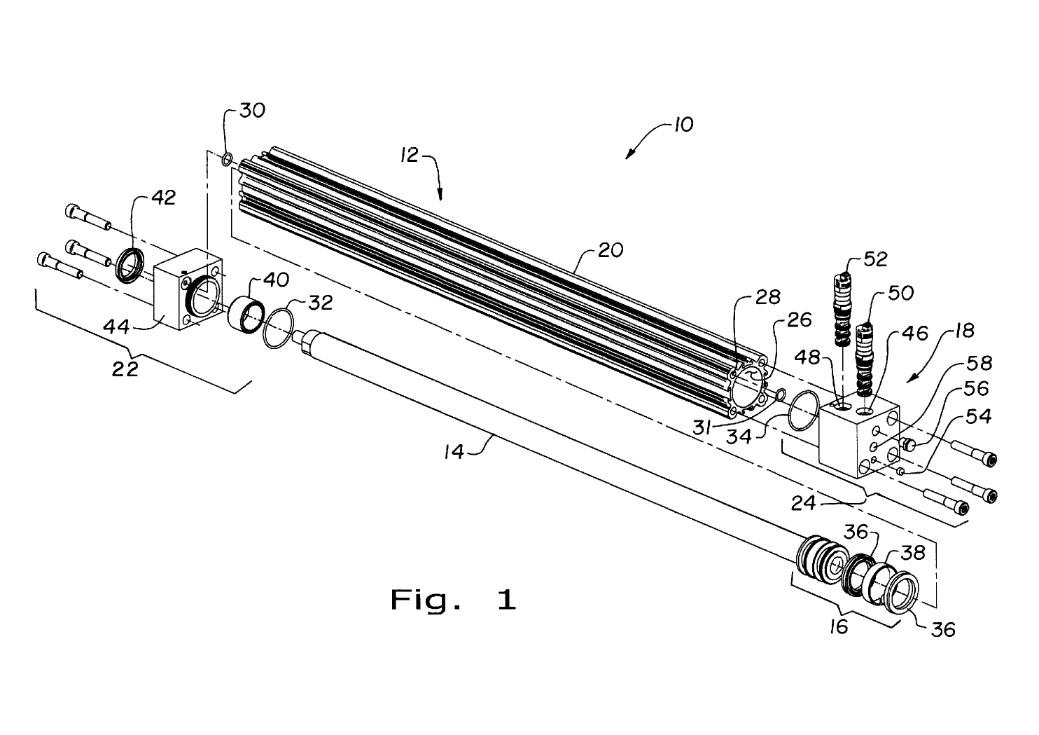

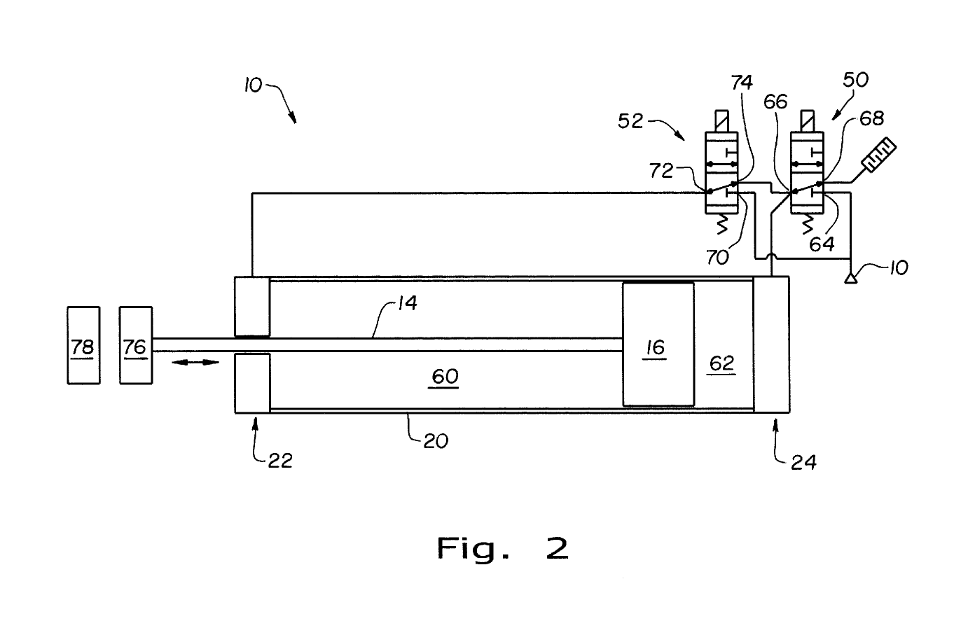

Referring now to the drawings and more particularly to FIGS. 1 and 2, there is shown a fluid articulator assembly 10, which may be a pneumatic articulator assembly 10, also referred to as a pneumatic cylinder assembly 10, including a cylinder assembly 12, a rod 14, a piston assembly 16 and a valve assembly 18. Cylinder assembly 12 includes a tube 20 affixed with end block assemblies 22 and 24 to form a cylinder housing. Tube 20 includes a main piston bore 26 and an internal air passageway 28 that extends through the entire length of tube 20. Seals 30, 31, 32 and 34 seal piston bore 26 and air passageway 28 in an airtight manner to end block assemblies 22 and 24. Tube 20 is illustrated as being an extrusion with interior air passageway 28 being integral therewith.

Piston assembly 16 and rod assembly 14 are slidable within cylinder assembly 12. In the embodiment illustrated of this invention, piston assembly 16 includes and is affixed with bi- directional piston seals 36 and a piston bearing 38. Rod end block assembly 22 includes a rod bearing 40 and a rod seal 42 affixed in block 44. Cap end block assembly 24 includes valve cavities 46 and 48 to accommodate an extend valve 50 and a retract valve 52 as well as internal passageways (shown schematically in FIG. 2) to communicate between valves 50 and 52, and piston bore 26, tube 20 internal passageway 28, breather vents 54 and 56, and a pressurized air supply port 58.

Referring now to FIG. 2, there is shown a schematic illustration of pneumatic articulator assembly 10. When retract valve 52 is in the position shown it interconnects rod end chamber 60 and head end chamber 62. Valve 50 has ports 64, 66 and 68 and valve 52 has ports 70, 72 and 74. As illustrated, retract valve 52 interconnects ports 72 and 74, and if extend valve 50 interconnects ports 64 and 66, then fluid pressure is applied to both sides of piston assembly 16, and the difference in surface area between the head end and the rod end of piston assembly 16 causes piston assembly 16 to move to the extended position adjacent end block assembly 22.

On the other hand, when extend valve 50 is in the position shown it interconnects ports 66 and 68, and when retract valve 52 is positioned to interconnect ports 70 and 72, then fluid pressure is applied to the rod end of piston assembly 16, and piston assembly 16 moves to the retract position adjacent to end block assembly 24 (shown).

In another embodiment, the rod bearing 40 and the rod end block 22 may be made as an integral assembly with the rod end block 22 bore surfaces used in place of a separate bearing 40.

In another embodiment, the piston bearing 38 may be omitted from the cylinder assembly.

In another embodiment a single uni-directional seal may replace the bi-directional seals 36.

In another embodiment, internal passageway 28 may be replaced by external tubing and fittings as a means of communicating pressurized air from the valves 50 and 52 to end block assembly 22.

In another embodiment, external valves connected to the cylinder by tubing may replace the cartridge style relay valves 50 and 52 and fittings or o-ring face seal type connections.

The diameter of rod 14 and piston assembly 16 are selected to provide approximately equal, nearly equal, or substantially equal, net surface areas when pressurized air acts on both sides of piston assembly 16 to extend rod 14 and acts only on the piston rod side of piston assembly 16 to retract rod 14. This is accomplished by making the surface area on piston assembly 16, proximate to head end chamber 62, twice the surface area on piston assembly 16 proximate to rod end chamber 60. The selection of the cross-sectional area of rod 14 to be approximately the same as the piston assembly 16 surface area associated with rod side chamber 60 allows for approximately the same force being applied to rod 14, in opposite directions, when valves 50 and 52 are sequenced as discussed herein. Advantageously, this reduces the physical size of the cylinder that is required in order to produce the desired extending force in rod 14. Rod 14 is connected to a mass 76, which can be a movable member 76 such as a door. The overall assembly of mass 76 with articulator assembly 10 can be referred to as a movable assembly. As mass 76 is extended away from articulator assembly 10, it may encounter an obstacle 78. In the prior art, pressure may build in head end chamber 62 and when obstacle 78 is removed, or yields, the built up pressure in head end chamber 62 (unchecked by pressure in rod end chamber 60) would cause mass 76 to be rapidly moved causing possible damage to the prior art cylinder assembly or to something that mass 76 may contact. In the present invention, this is prevented or moderated by communicating pressurized air to both sides of the piston as rod 14 is extended, a pathway is provided to maintain balanced air pressure on both sides of the piston when an outside force acts to overcome air pressure and cause the piston rod to retract.

The term “moderate pressure” is what occurs within the cylinder such that compressible fluid pressure is applied to both sides of a piston so that movement of rod 14 is moderated when mass 76 encounters an obstacle 78. This is also described as a damping method. The moderation takes the form of reduced outward movement of rod 14 when obstacle 78 is taken away so that rod 14 continues an outward movement in the form of a “moderated” movement as compared to what would happen without the application of compressible fluid pressure to both sides of the piston.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A movable assembly, comprising:
a movable structure;
a fluid cylinder assembly coupled to said movable structure, said fluid cylinder assembly including:
a cylinder;
a rod assembly including:
a rod having a first end and a second end; and
a piston slidingly positioned in said cylinder, said piston being connected to said first end of said rod, said second end of said rod extending from said cylinder; and
a valve assembly in fluid communication with said cylinder, said valve assembly configured to moderate pressure within said cylinder when an external force is applied against said second end of said rod.

2. The movable assembly of claim 1, wherein said cylinder and said piston coact to form a head end chamber and a rod end chamber within said cylinder, said valve assembly being configured to provide a substantially similar pneumatic pressure to both said head end chamber and said rod end chamber when said valve assembly is positioned to extend said rod from said cylinder.

3. The movable assembly of claim 1, wherein said cylinder and said piston coact to form a head end chamber and a rod end chamber within said cylinder, said valve assembly being configured to provide a similar pneumatic pressure to said head end chamber and said rod end chamber to thereby create a net force on said rod assembly in a longitudinally outward direction.

4. The movable assembly of claim 3, wherein said head end chamber and said rod end chamber are fluidly connected when said valve assembly is configured to create said net force.

5. The movable assembly of claim 4, wherein said piston has a first surface area associated with said head end chamber, said piston having a second surface area associated with said rod end chamber, said first surface area being approximately twice said second surface area.

6. The movable assembly of claim 4, wherein said piston has a surface area associated with said rod end chamber, said rod having a cross-sectional area approximately the same as said surface area.

7. The movable assembly of claim 1, wherein said valve assembly is configured to use a single pressure source to provide substantially equal force to said rod in each of two directions of travel, said cylinder being an extrusion with an integral fluid passageway.

8. The movable assembly of claim 7, wherein said piston has a surface area associated with a rod end chamber of the cylinder assembly, said rod having a cross-sectional area approximately the same as said surface area.

9. A fluid cylinder assembly, comprising:
a cylinder;
a rod assembly including:
a rod having a first end and a second end; and
a piston slidingly positioned in said cylinder, said piston being connected to said first end of said rod, said second end of said rod extending from said cylinder; and
a valve assembly in fluid communication with said cylinder, said valve assembly configured to moderate pressure within said cylinder when an external force is applied against said second end of said rod.

10. The fluid cylinder assembly of claim 9, wherein said cylinder and said piston coact to form a head end chamber and a rod end chamber within said cylinder, said valve assembly being configured to provide a substantially equal pneumatic pressure to both said head end chamber and said rod end chamber when said valve assembly is positioned to extend said rod from said cylinder.

11. The fluid cylinder assembly of claim 9, wherein said cylinder and said piston coact to form a head end chamber and a rod end chamber within said cylinder, said valve assembly being configured to provide a similar pneumatic pressure to said head end chamber and said rod end chamber to thereby create a net force on said rod assembly in a longitudinally outward direction.

12. The fluid cylinder assembly of claim 11, wherein said head end chamber and said rod end chamber are fluidly connected when said valve assembly is configured to create said net force.

13. The fluid cylinder assembly of claim 12, wherein said piston has a first surface area associated with said head end chamber, said piston having a second surface area associated with said rod end chamber, said first surface area being approximately twice said second surface area.

14. The fluid cylinder assembly of claim 12, wherein said piston has a surface area associated with said rod end chamber, said rod having a cross-sectional area approximately the same as said surface area.

15. The fluid cylinder assembly of claim 9, wherein said valve assembly is configured to use a single pressure source to provide substantially equal force to said rod in each of two directions of travel.

16. The fluid cylinder assembly of claim 15, wherein said piston has a surface area associated with a rod end chamber of the cylinder assembly, said rod having a cross-sectional area approximately the same as said surface area.

17. A method of damping a movement of a fluid cylinder assembly, the method comprising the steps of:
fluidically coupling a valve assembly to the fluid cylinder assembly; and
moderating pressure within the fluid cylinder using said valve assembly such that when an external force is applied against movement of an end of a rod extending from the fluid cylinder assembly a substantially equal fluidic pressure is applied to both sides of a piston coupled to said rod.

18. The method of claim 17, wherein said cylinder and said piston coact to form a head end chamber and a rod end chamber within said cylinder, said valve assembly being configured to provide a substantially similar pneumatic pressure to both said head end chamber and said rod end chamber when said valve assembly is positioned to extend said rod from said cylinder.

19. The method of claim 18, wherein said head end chamber and said rod end chamber are fluidically connected when said valve assembly is in said valve position selection.

20. The method of claim 19, wherein said piston has a first surface area associated with said head end chamber, said piston having a second surface area associated with said rod end chamber, said first surface area being approximately twice said second surface area.
